(19) United States
(12) Patent Application Publication
(10) Pub. No.: US 2012/0159331 A1
(43) Pub. Date: Jun. 21, 2012

(54) Audience Response System

(76) Inventors: Robert Greve, Edmond, OK (US); Luke Woodard, Edmond, OK (US)

(21) Appl. No.: 12/972,047

(22) Filed: Dec. 17, 2010

(51) Int. Cl. G06F 3/00; G06F 15/16

(52) U.S. Cl. 715/730; 709/206

(57) ABSTRACT

An audience response system comprising: at least one audience means for communicating with the system and displaying information to audience members; a presenter means for communicating with the system and displaying information to the presenter; a central server storing and analyzing data associated with the system and adapted to allow at least one audience means and the presenter means to communicate with the system using at least one common communication network and protocol; at least one communications network facilitating transmission of data among the server, audience means and presenter means; and a display means for showing an output of the system to the audience. The system may be adapted to use at least one selected from a cellular telephone, a wired computer network, and a wireless computer network, and the audience and presenter may use cellular telephones, personal computers, personal digital assistants, and digital web-enabled music devices to communicate with the system. Communication protocols may include hypertext transfer protocol (“HTTP”), multimedia message service (“MMS”), and short message service (“SMS”). Communication in the system may be facilitated on at least one device by a browser including, but not limited to Chrome, Firefox, Internet Explorer, Opera, and Safari.

### FIELD OF INVENTION AND PRIOR ART

The invention relates to audience response systems and, more particularly, to electronic systems for soliciting, receiving and processing audience input.

A typical audience response system, which may also be referred to as personal response or group response system is comprised of the following components: 1) audience devices such as, in modern systems, wireless keypads, 2) a base station or receiver for receiving signals from the audience devices and, in two-way systems, for broadcasting a signal back to the audience devices, and 3) audience response system control hardware—a computer with system software in modern systems. The base station receives the participant responses from remote keypads and stores the answers in a database that resides on the computer as part of the audience response system software. The results can be displayed instantly in graph or other format, and the data can later be retrieved in a variety of reporting formats. Most keypad software comes with the ability to tabulate results and format them in a form exportable to Microsoft Excel®. Most software allows for lecturers to be able to weave the keypad questions into Microsoft PowerPoint®. Depending on the presenter's requirements, the data can either be collected anonymously or it can be traced to individual participants in circumstances where tracking is required.

The participants in the system will generally be referred to as a “presenter,” and the “audience.” “Presenter” is generally synonymous in this context with instructor, facilitator, team leader, and similar terminology. The presenter is the person or persons most responsible for the content and conduct of the course or presentation during which the audience response system is being used. The presenter may include one or more behind-the-scenes persons responsible for administering the audience response system and/or for selecting questions or input to be used or displayed in the system. A particular course, seminar, presentation, lecture or the like may have multiple presenters, and they may change during the course of the session. One example of instances where multiple presenters may be present includes a panel discussion where a plurality of persons are on a dais discussing a topic at the same time. Another example of an instance with several presenters is a seminar where several presenters in sequence address sub-parts of the topic at hand, each one handing off the session to the next presenter once they have completed addressing their portion. In some cases, it may be desirable to have a non-speaking assistant working with the speaking presenter for the purpose of administering one or more components of an audience response system. All of the foregoing persons and scenarios are generally encompassed and anticipated in the use herein of the term “presenter.” “Audience” means the people attending the course, seminar, presentation, lecture, or the like as distinguished from a presenter. The audience is comprised of persons attending the session primarily, at some point in time, to receive information from one or more presenter. As noted, presenters may change during a session, so they may pass at some point from the role of a presenter to the role of an audience member during the course of a session. There is no need to irreversibly view any person at a particular course as either a presenter or an audience member, but for clarity of language herein, those roles will be discussed generally as though they were clearly defined. In some settings, the roles will be well-defined (such as a university classroom setting with an instructor and students), while in other settings, the roles may seamlessly change (such as a work group of colleagues addressing an area of common concern). “Presentation” will generally be used as the term to reference a session where an audience response system is used, but it is generally synonymous with class, seminar, lecture or the like.

Prior art systems typically included dedicated audience input devices that were specifically developed for and used exclusively in the audience response system. A typical prior art system is illustrated in U.S. Pat. No. 5,226,177 to Nickerson for a Real-Time Wireless Audience Response System. Nickerson included a dedicated device for allowing audience input, which it described as a “hand-held, wireless response unit preferably contains a 3-position, 7-segment LCD screen for displaying messages sent from the central processor, the push-button keypad for registering responses, an addressable asynchronous receiver/transmitter, an RF receiver/transmitter . . . preferably a Motorola MCI4469 IC.” These prior systems had numerous limitations, not the least of which was the cost of providing system-specific input consoles, retrieving them at the end of each class or presentation, and also the limited nature of input that can be provided by the audience. In essence, the older prior art systems limited audience input to selecting a limited number or type of responses to queries posed in a structured fashion by the presenter.

A more modern audience response system is shown at www.turningtechnologies.com. The web site describes the technology thus: “TurningPoint audience response system integrates 100% into Microsoft® PowerPoint® and allows audiences and students to participate in presentations or lectures by submitting responses to interactive questions using a ResponseCard™ keypad or other hand-held/computer devices. Using a TurningPoint audience response system, your PowerPoint presentations become powerful data collection and assessment tools that collect real-time audience responses and dramatically improve productivity and results for your business or educational organization. Author, deliver, assess and report without ever leaving PowerPoint.” The site illustrates an application toolbar on its down-loadable software, which inserts a slide created by the software into a PowerPoint presentation. See http://www.turningtechnologies.com/audienceresponseproducts/pollingsoftware/turningpoint/. The software gives a presenter the option to insert several different types ofpre-selected question formats into a presentation. Then, the system collects audience responses and displays the results in an appropriate format in a presentation slide.

Turning Technologies offers a variety of ResponseCard® keypads (“clickers”) to address specific audience/student response goals and objectives. These interactive audience participation keypads are designed to support the functionality of the system. Alternatively, Turning Technologies allows the audience to respond on their computer or mobile device by one of two means: (1) using a browser-based facility, or by using a (2) device-specific application. In the first instance, using a browser-based facility, ResponseWare requires no special software to install or configure and no need to alter firewall or port settings. The system supports nearly all JavaScript™-enabled web browsers across multiple platforms and operating systems. Turning Technologies provides all of the hosting and web services necessary for a ResponseWare web-enabled interactive polling session, which eliminates the need for any organization to host, maintain, and support the application and allows for immediate utilization of the response technology. Alternatively, in the second instance, participants can download ResponseWare software developed specifically for the iPhone, iPod Touch® or BlackBerry® devices to take advantage of the specific features and functionality available with the device.

The ResposneWare system can receive feedback from compatible clickers via either infrared (“IR”) or radio frequency (“RF”) transmission. Multiple devices are provided, including a handheld receiver that can process RE responses, and does not need a computer or projector to monitor audience feedback. Alternatively, an IR or RF receiver can translate received signals for use on a computer or other device via a communication cable. Where the browser-based implementation is used, audience input travels to the system through either a wireless fidelity (“WIFI”) connection or through the cellular telephone network by way of a data connection. No disclosure is made on the ResponseWare site regarding use of short message service (“SMS” or “text messages”) for communication or multimedia message service (“MMS” or “picture messages”) to communicate with the ResponseWare system. Therefore, when the ResponseWare site refers to communication via a cellular “data connection,” it seems that the site refers only to data transmission using a browser.

Browser-based systems are in the early stages of development and use. They are intended to work with the participants' existing wireless devices, such as notebook computers or personal digital assistants (PDAs). The software resides on the presenter's computer. The presenter creates a polling session with an assigned Internet provider (IP) address. Participants log-in to that IP address through their own Internet-enabled device. The participant data is transmitted through the IP address to the presenter's computer, where the data is stored. The data can then be displayed through the projector and also on each participant's wireless device. The Turning Point system discussed above is one example of a system that is, at least in part, browser-based.

Browsers in common use as of the writing of this document include Chrome®, Firefox®, Internet Explorer®, Opera®, and Safari®. Other browsers have been used in the past and have essentially ceased being used (such as Netscape®), others are currently available commercially, and undoubtedly new browsers will be developed in the future. However, a browser generally herein includes the foregoing as well as any other application that facilitates retrieving, presenting, and traversing information resources on the World Wide Web or Internet. An information resource is identified by a Uniform Resource Locator (URL) and may be a web page, image, video, or other piece of content. Hyperlinks present in resources enable users to easily navigate their browsers to related resources. Although browsers are primarily intended to access the World Wide Web, they can also be used to access information provided by servers in private networks or files in file systems. Some browsers can also be used to save information resources to file systems.

The concept of a “question” is integral to an audience response system. Questions can be formatted in a number of ways such as yes/no and true/false. Multiple choice questions typically have a lead-in statement or question (called the stem) followed by multiple options from which each person selects a single choice. The choices generally consist of a right answer and several wrong ones and/or a series of alternatives from which the participants can pick their preferred choice (e.g., most likely, most important). Ways to use the “series of alternatives” format include case studies in which the participants are asked to choose the best diagnosis or solution to the problem, or presentation of a perplexing dilemma or competing choices from which the participants are asked to select the one that they feel is most compelling. Multiple choice questions may include a “not sure” or “don't know” option as well. Not every question needs to be a test question with a right and wrong answer. Likert-scale questions (on a scale of 1 to 10, for example) provide an outlet for participants to express opinions about important topics, and allow participants to see how their opinions compare to those of the other participants. Such opinion-scale items generally take the form of a statement, with a request for each person's level of agreement. The response choices are on a continuum in which one end of the scale represents one extreme, such as “clearly disagree” and the other end represents the other extreme, such as “clearly agree.”

### SUMMARY OF THE INVENTION

An audience response system comprising: at least one audience means for communicating with the system and displaying information to audience members; a presenter means for communicating with the system and displaying information to the presenter; a central server storing and analyzing data associated with the system and adapted to allow at least one audience means and the presenter means to communicate with the system using at least one common communication network and protocol; at least one communications network facilitating transmission of data among the server, audience means and presenter means; and a display means for showing an output of the system to the audience. The system may be adapted to use at least one selected from a cellular telephone, a wired computer network, and a wireless computer network, and the audience and presenter may use cellular telephones, personal computers, personal digital assistants, and digital web-enabled music devices to communicate with the system. Communication protocols may include hypertext transfer protocol (“HTTP”), multimedia message service (“MMS”), and short message service (“SMS”). Communication in the system may be facilitated on at least one device by a browser including, but not limited to Chrome, Firefox, Internet Explorer, Opera, and Safari.

The central server may store data related to a particular presentation, the data to be stored including, but not limited to questions (whether audience- or presenter-generated), possible responses, statistical data associated with past responses, presentation subject matter, presentation name, title of the data, a rating of the data's quality, and notes about the data. The audience may be allowed to provide feedback to the presenter regarding their level of agreement with a particular question or bit of data, and that feedback may also be stored in the central server. Further, the central server may analyze audience responses regarding their level of agreement and providing feedback to the presenter associated with statistical analysis of the audience feedback.

The audience response means may be selected from the group comprising: iPhones and similar devices, Blackberry-compatible devices, Droid-compatible devices, and Windows Mobile-compatible devices. Each audience response means may include more than one display device, each of which is viewable by a subset of the audience. For example, several audience members could share an iPhone in communication with the system.

The audience means may have installed thereon an application specifically written to facilitate communication with the system from devices of the type being used by the audience member. This device-specific software will be familiar to iPhone users who can download specific software that then is represented as an icon on the iPhone. For example, iPhone users can access Facebook® through the Safari browser available on their phone or, alternatively, they can download a Facebook application (or “app”) that facilitates communication of the iPhone with Facebook and presents the users' information in a format more appropriate for viewing on the iPhone. Communications with Facebook still occur via the Internet, but the formatting of the screens viewed by a user are formatted differently.

Alternatively, the audience response system may comprise a communication network; a central server for storing system data and facilitating communication among devices connected to the system; at least one audience device adapted to facilitate audience input and viewing data sent to it by the system; at least one presenter device adapted to allow a presenter to input data and to view data sent to it by the system; at least one database storing information input thereto by at least one presenter and at least one audience member; an audience interface making available to at least one audience member information selected from—at least one question posed by a presenter, at least one question posed by other audience members, data from a presenter, data from at least one other audience member, and analysis of responses to at least one question, data from a presenter, or data from at least one audience member; and a presenter interface making available to at least one presenter information selected from—a questions posed by a presenter, a question posed by other audience members, data from a presenter, data from at least one audience member, information from the database, and analysis of the preceding categories of information.

In this embodiment, the central server may retain at least one account for at least one presenter and for retaining data associated with at least one presentation offered by that presenter, as well as at least one account for at least one audience member and for retaining data associated with at least one presentation in which that audience member participates. Audience devices may give an audience member the capability to input into the system for display to at least a presenter at least one of the following—a text-based observation related to the presentation, their level of agreement with a text-based observation of at least one other audience member, a response to a question posed by a presenter, and a response to a question posed by another audience member.

In another embodiment of the system, the presenter interface may have a display screen showing at least audience input and providing the option of the presenter selecting particular audience input for segregation into at least one of the following categories of audience inputs: audience input displayed on at least one audience device; audience input retained for future use by a presenter; and audience input posed to the audience as a question. Audience input may be selected for segregation into one of the foregoing categories by at least one of the following mechanisms: presenter selection; audience selection; and selection by audience input satisfying specified statistical criteria. The audience interface may offer each audience member the capability to input into the system for display to at least a presenter at least one of the following—a text-based observation related to the presentation, their level of agreement with a text-based observation of at least one other audience member (a “ditto” feature), a response to a question posed by a presenter, and a response to a question posed by another audience member. This embodiment allows a presenter the option of, on the fly during a presentation, selecting specific real-time audience input for display on the screen as a discussion topic or as a question posed back to the generalized audience. This real-time input feature allows the presenter to react to the level of understanding or interest in a particular portion of the presentation to enhance the understanding of the audience or keep its interest level peaked.

An example of an embodiment of an audience response system may comprise: (a) a communication network—selected from at least one of a cellular telephone network, a wireless computer network, and a wired computer network, and using at least one of HTTP, MMS, and SMS; (b) a central server for storing system data and facilitating communication among devices connected to the system; (c) at least one audience device adapted to facilitate audience input and viewing data sent to it by the system, including the capability to input into the system for display to at least a presenter at least one of the following—a text-based observation related to the presentation, their level of agreement with a text-based observation of at least one other audience member, a response to a question posed by a presenter, and a response to a question posed by another audience member; (d) at least one presenter device adapted to allow a presenter to input data and to view data sent to it by the system; (e) at least one database storing information input thereto by at least one presenter and at least one audience member, the database retaining at least one account for at least one presenter and for retaining data associated with at least one presentation offered by that presenter; (f) a browser-based audience interface making available to at least one audience member information selected from—at least one question posed by a presenter, at least one question posed by other audience members, data from a presenter, data from at least one other audience member, and analysis of responses to at least one question, data from a presenter, or data from at least one audience member; and (g) a browser-based presenter interface making available to at least one presenter information selected from—a question posed by a presenter, a question posed by other audience members, data from a presenter, data from at least one audience member, information from the database, and analysis of data from the audience.

### BRIEF DESCRIPTION OF THE DRAWINGS

FIG. 1 shows an implementation of the system using the cellular network for communication with two different audience means with the central server and a WIFI network for communication among the central server and another audience means and a presenter mean, while a signal is sent to a display means via an ethernet.

FIG. 2 shows communication options for an cellular telephone functioning as an audience means.

FIG. 3 shows an implementation of the system using an iPad as a presenter means allowing the presenter to select audience input for later use or for immediate display to the audience on a display means.

FIG. 4 shows a screen a presenter might see at the time they log into the system.

FIG. 5 shows a screen an audience member might see at the time they log into the system.

FIG. 6 shows a screen an audience member might see when they enter a question.

FIG. 7 shows a screen an audience member might see to give their feedback on audience-created questions.

FIG. 8 shows a screen a presenter might see giving them options on how to segregate audience-created questions.

FIG. 9 shows a screen a presenter might see listing audience-created questions the presenter has selected to be “on hold.”

FIG. 10 shows a screen a presenter might see listing audience-created questions being displayed to the audience.

### DETAILED DESCRIPTION OF THE PREFERRED EMBODIMENTS

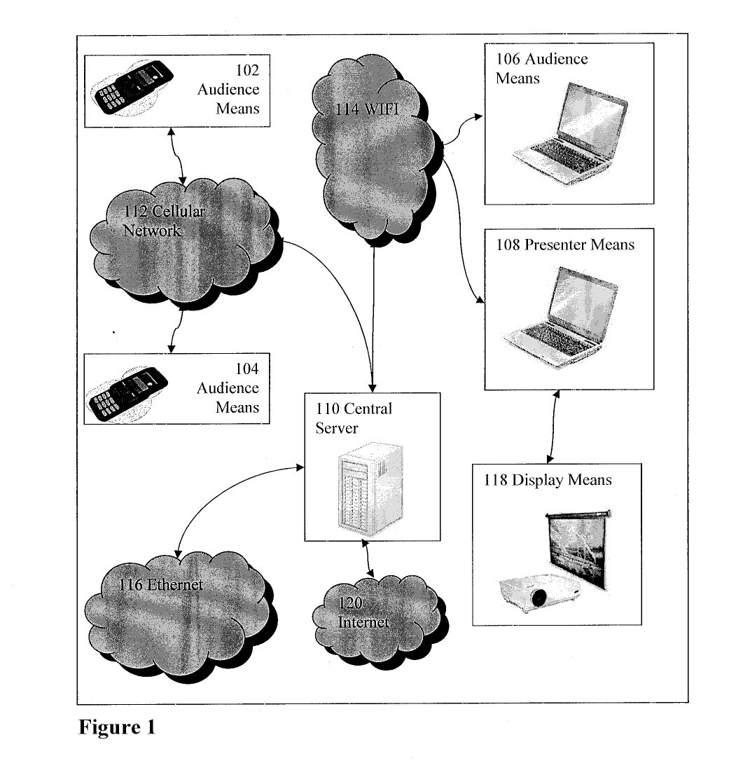

The system as shown in FIG. 1 includes multiple audience means, in this example, two audience means 102 and 104 communicating with the system via a cellular network 112 as well as an audience means 106 communicating with the system via a WIFI network 114. A presenter means 108 is also communicating with the system via the WIFI network 114. A central server 110 can communicate with devices via multiple routes including, but not limited to, via the cellular network 112, the WIFI network 114, and an ethernet network 116. The central server 110 is also preferably in communication with the Internet 120 so that audience means and even presenter means can interact with the system without all being in the same location. A display means 118 is, in FIG. 1, receiving a display shown to the audience.

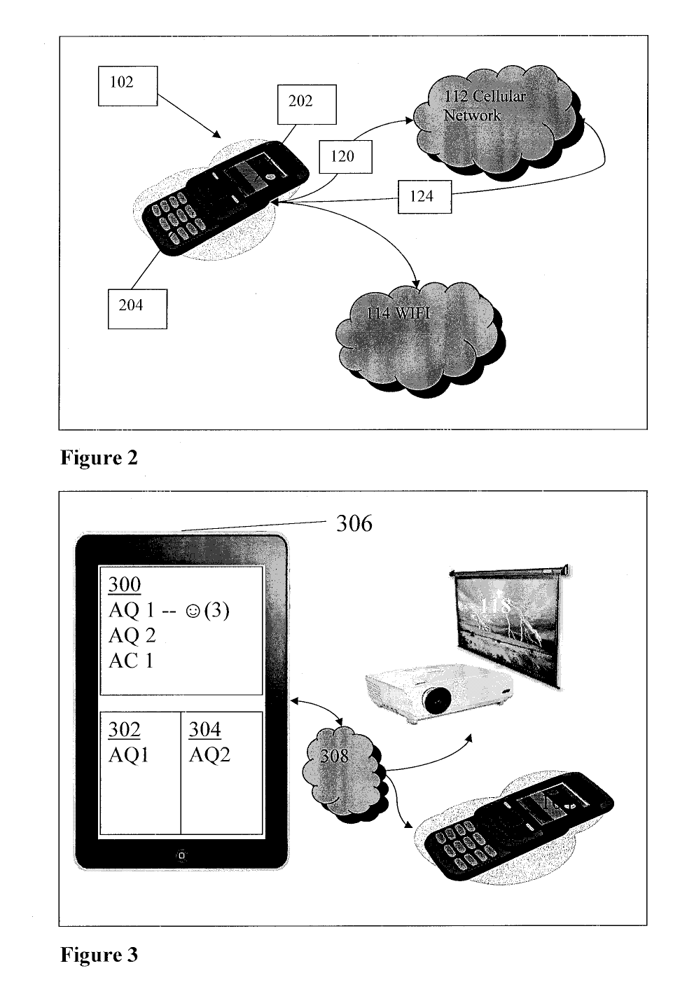

The audience means 102 is illustrated in more detail in FIG. 2. The audience means 102 preferably has a display means 202, a data input means 204, and the capacity to communicate via at least three different modes: (1) via message services 120, either MMS or MMS on a cellular network 112; (2) via data transmission services 124 on the cellular network 112; or (3) via a WIFI network 114. The audience means may also communicate via the Internet 120 with the central server 110.

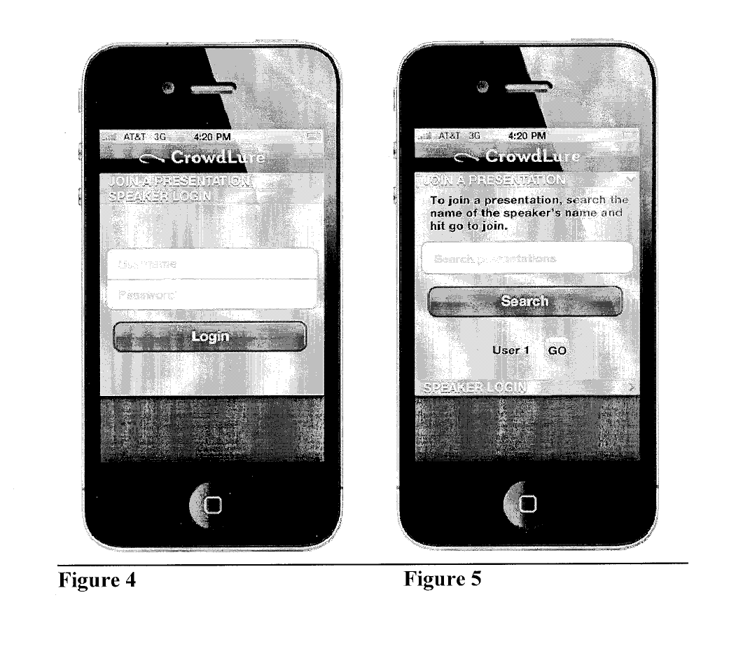

The audience means 102, 104, and 106, may be selected from the group of cellular telephones, personal computers, personal digital assistants, and web-enabled digital music devices. There are a wide variety of devices on the market that can serve as the audience means, including, but not limited to iPhones, Blackberry-compatible devices, Droid-compatible devices, Windows Mobile-compatible devices, iPads, tablet personal computers (“tablet PCs”), laptop computers, and even desktop computers. The primary requirement for devices that serve as an audience means is that they have the ability to communicate via a network with the central server 110. Preferably, audience means will also have a display means 202 and a data input means 204. The display means 202 will be some sort of screen, whether it is liquid crystal display (“LCD”), thin film transistor (“TFT”), electronic ink, or one of the myriad types of screens available for display of information now or in the future. Data input means 204 may be a keypad/keyboard as shown in FIG. 2, or it may be a touch screen of the type available on the iPhone as illustrated in FIGS. 4 to 10. Voice input of data may also be available, and this option would be useful for distance learning environments, but having multiple audience members speaking at the same time in the same room to enter data would likely be impractical. In some instances, software specifically written for the system may be installed on the audience means, likely in the form of a platform/device specific “app” written to accommodate the screen size and other limiting factors exhibited by the platform/device. However, the baseline system will preferably be capable of operating independent of any specific application software by using HTTP via a commercially available browser.

The discussion above regarding audience means 102, 104, and 106, applies to the presenter means 108. The presenter means may communicate via the same methods, and it may be comprised of the same types of devices. However, given that a present may have more work regarding selection of information to be displayed and regarding data entry, the presenter device may have a relatively larger screen, and a physical keyboard may be desirable where a presentation uses Powerpoint or similar presentation software.

The display means 118 may be a traditional overhead screen or other type of large format device available for viewing by most or all of the audience members as is shown with a projector and screen in FIG. 1. However, the display means may be a series of smaller display monitors available to a sub-set of the audience, or even may be the individual display means 202 incorporated into the audience means 102. Where the display means 118 is exclusively the individual display means 202, not all audience members must have their own dedicated audience means 102 as one or more audience members may share an audience means 102. Traditionally, the display means 118 has been connected by a cable fed directly from the presenter means 108. However, its signal may come through the Internet 120 and be processed by a local computer that ends up being connected by a cable directly to the display means 118.

FIG. 3 shows an implementation of the present invention that may be referred to by the trade name of CrowdLure™. The presenter interface for CrowdLure is shown as it might appear on an iPad 306. The top circa half of the scrolling audience question are 300 contains a list of audience questions, AQ 1 and AQ 2, as well as an audience comment, AC1. The presenter has segregated one of the audience questions, AQ1, in an “on hold” area 302, and another audience question, AQ2, in an “on screen” area 304. Questions in the on hold area 302 are retained for viewing and use by a presenter, but segregation of a question into the on hold area 302 does not cause it to be displayed to audience members. Questions segregated into the on screen area 304 are displayed to audience members.

The CrowdLure embodiment allows the presenter means 108, or as illustrated in FIG. 3, an iPad 306, to communicate information through a network 308 directly to multiple audience means 104 and also optionally to a larger format display means 118. All the modes of communication discussed above may be used in the CrowdLure implementation including, but not limited to, a cellular network, a WIFI network, and ethernet network, and the Internet. The central server is not shown in FIG. 3, but it is present and in communication with system devices via one a communication network.

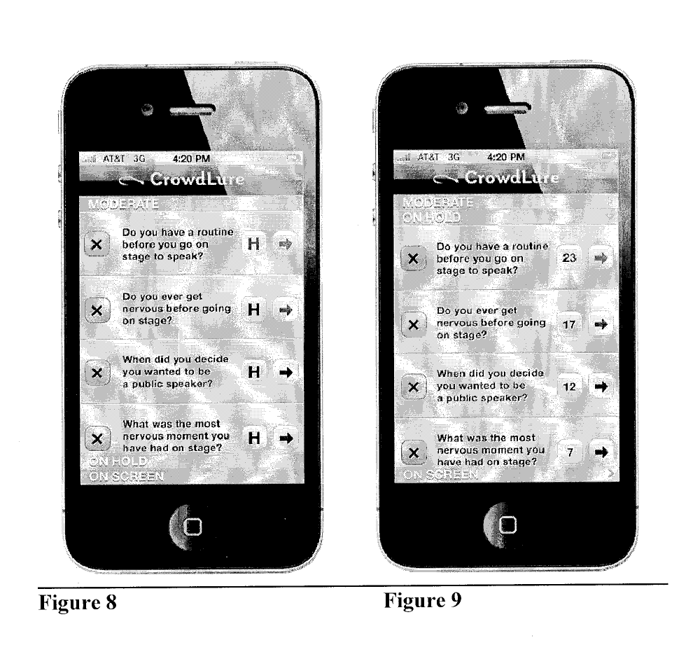

A presenter may find a particular question displayed in the scrolling audience question area 300 interesting, so he may segregate it into the on screen area 304 for use in the presentation. When implemented on an iPad or another device with a touch screen, questions may be dragged from the scrolling area 300 into the on screen area 304 or on hold area 302 by a user “dragging” them with a finger touch from one area to another. Another way to move items from one area to another is illustrated in FIG. 8. FIG. 8 is a screen that a presenter might see showing four questions that have been posed by an audience. Each question has several options available with respect to it: (1) an “x-out” box, which a presenter can use to strike a question from the system; (2) an “H” box, which a presenter can use to put a question into the hold area 302, and (3) an “arrow” or “on-screen” box, which a presenter can use to immediately put that question on display for the audience.

FIGS. 4-10 illustrate a CrowdLure embodiment as it may appear to both audience members and presenters if they are using iPhones and communicating with the system via data transfer on a cellular network or a WIFI network. FIG. 4 shows a login screen for a presenter/speaker. Using a standard username and password combination, the presenter logs into the system to join a presentation. The iPhone shown in FIG. 4 is a presenter means 108 as that term is used herein. FIG. 5 shows a screen an audience member might see to join a presentation. The iPhone shown in FIG. 5 is an audience means 102, 104, or 106, as that term is used herein. The audience member types in the speaker/presenter's name, as an example, and searches for presentations in the system associated with that name. From a search results list, the audience member selects the desired presentation and hits the “go” button. This allows the audience member to communicate with the system, and for his comments to be viewed by the presenter.

The embodiment shown in FIG. 5 does not require a username and password for the audience members; such a configuration would be preferable in a corporate/governmental presentation environment where audience participation does not need to be tracked for grading or evaluation purposes. In, for example, an educational setting, audience members may be required to log in so that they can be specifically identified to the system, and their input tracked for grading or evaluation purposes. Where audience members need to be tracked, a login screen like the one shown in FIG. 4 may be used for audience members.

Where an iPhone or similar device is used as the audience means 102, 104, or 106, the system may take advantage of the geographic indicators that can be transmitted by the iPhone and similar devices as a check on who can participate in the presentation. iPhones and many other portable electronic devices can detect their location via either a cellular telephone network 112 or via a global positioning satellite (“GPS”) system. This location data can be transmitted by the iPhone or similar devices. The description of these types of services present on http://en.wikipedia.org/wiki/Mobile_phone_tracking is hereby incorporated by reference, and the current version of that web page is submitted along with submission of the application for patent. To prevent persons not actually present at the site from participating in a presentation, the system may require that location information be transmitted by the audience means to ensure that all participants are physically at the location where the presentation takes place.

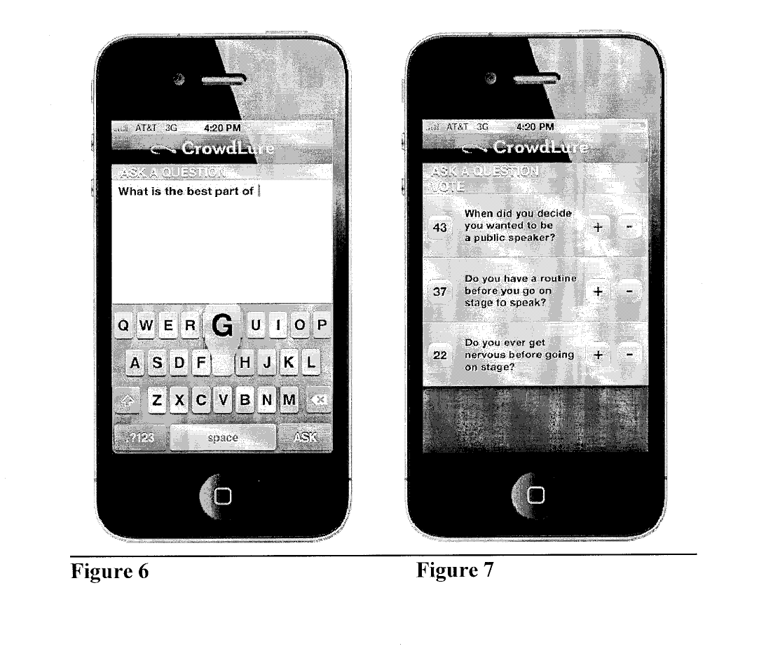

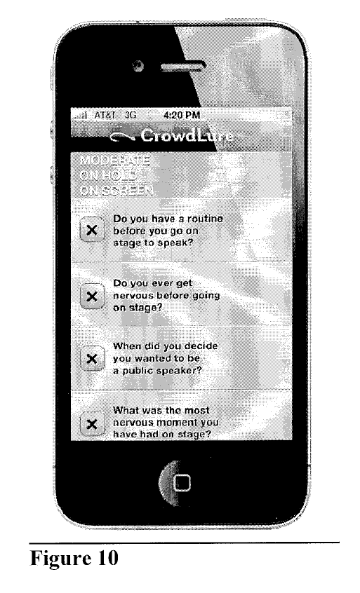

FIGS. 6 and 7 illustrate an audience member interface on a CrowdLure implementation of the system. FIG. 6 shows an audience member entering a question using the touch-screen keyboard. FIG. 7 shows a list of audience-submitted questions on which the audience member can “vote” indicating by a “+” that he agrees with, seconds, or otherwise approves of the question or, alternatively, indicating by a “−” that he disagrees with or otherwise disapproves of the question. The audience member can thus indicate a “ditto” to a question generated by another audience member. A presenter can thus be alerted when a number of audience members want an answer to the same question, which may be the case when a presenter fails to adequately explain a particular topic within the presentation. Other options for audience input on comments or questions generated by them or by the presenter may be offered. A button may allow an audience member to comment on another's question. This comment feature will be familiar to those who have used, for example, Facebook or YouTube, which allow users to make comments on particular items. FIG. 9 shows how audience input may be displayed to the presenter as a summary. The questions shown in FIG. 9 have been voted on by audience members using either a “+” or a “−,” and the net result is shown as a number. In other words, for the first question shown in FIG. 9, the number 23 is associated. That number indicates that a net 23 positive votes have been received, which could reflect 30 audience members voting “+” and seven audience members voting “−”. The larger the number, the more positively the audience views the question or the more interesting they find it.

FIGS. 8 to 10 illustrate a presenter interface on a CrowdLure implementation of the invention. FIG. 8 may be the first screen a presenter sees. The questions entered by audience members scroll through, and the presenter has the option to segregate interesting questions. As noted above, FIG. 8 is a screen that a presenter might see showing four questions that have been posed by an audience. Each question has several options available with respect to it: (1) an “x-out” box, which a presenter can use to strike a question from the system; (2) an “H” box, which a presenter can use to put a question into the hold area 302, and (3) an “arrow” or “on-screen” box, which a presenter can use to immediately put that question on display for the audience. Putting a question into the hold area 302, also shown in an alternative embodiment in FIG. 8, may automatically make the question appear as a polling inquiry to the audience, as illustrated in FIG. 7. FIG. 7, as shown, indicates by a number adjacent to each question the number of audience members who have voted on a particular question. The questions on which audience members are voting preferably appear only on their audience means, and the questions displayed on a larger display means 118 viewable by a wider share of the audience are selected by an arrow on FIG. 8, and then listed in a screen illustrated in FIG. 10. Again an “x-out” screen appears in FIG. 10, which allows a presenter to strike particular questions from display to the audience.

Having thus described the preferred embodiments, I claim:

1. An audience response system comprising:
a. at least one audience means for communicating with the system and displaying information to an audience member;
b. a presenter means for communicating with the system and displaying information to the presenter;
c. a central server storing and analyzing data associated with the system and adapted to allow at least one audience means and the presenter means to communicate with the system using at least one common communication network and protocol;
d. at least one communications network facilitating transmission of data among the server, audience means and presenter means; and
e. display means for showing an output of the system to the audience.

2. The audience response system of claim 1 adapted to use at least one selected from a cellular telephone, a wired computer network, and a wireless computer network.

3. The audience response system of claim 2, the audience means selected from the group of cellular telephones, personal computers, personal digital assistants, and digital music devices.

4. The audience response system of claim 3, the presenter means selected from the group of cellular telephones, personal computers, personal digital assistants, and web-enabled digital music devices.

5. The audience response system of claim 4, the communication protocols selected from at least one of HTTP, MMS, and SMS.

6. The audience response system of claim 5, communication facilitated on at least one device by a browser.

7. The audience response system of claim 5, the browser selected from the group of Chrome, Firefox, Internet Explorer, Opera, and Safari.

8. The audience response system of claim 6, the central server storing data related to a particular presentation.

9. The audience response system of claim 8, the central server checking location data automatically transmitted by an audience means against a known location of a presentation before an audience member is allowed to participate in the presentation.

10. The audience response system of claim 9, the presentation-related data selected from questions, possible responses, statistical data associated with past responses.

11. The audience response system of claim 10, the presentation-related data grouped by categories selected from presenter, presentation subject matter, presentation name, title of the data, a rating of the data's quality, and notes about the data.

12. The audience response system of claim 6, the audience means providing audience members with a tool for providing feedback to the presenter regarding their level of agreement with a particular matter.

13. The audience response system of claim 12, the central server analyzing audience response regarding their level of agreement and providing feedback to the presenter associated with statistical analysis of the audience feedback.

14. The audience response system of claim 6, the audience display means including more than one display device, each of which is viewable by a subset of the audience.

15. The audience response system of claim 6, the audience means having installed thereon an application specifically written to facilitate communication with the system from devices of the type being used by the audience member.

16. The audience response system of claim 15, the audience means selected from the group comprising: iPhone compatible devices, Blackberry-compatible devices, Droid-compatible devices, and Windows Mobile-compatible devices, iPads, tablet PCs, laptop computers, and desktop computers.

17. An audience response system comprising:
a. a communication network;
b. a central server for storing system data and facilitating communication among devices connected to the system;
c. at least one audience device adapted to facilitate audience input and viewing data sent to it by the system;
d. at least one presenter device adapted to allow a presenter to input data and to view data sent to it by the system;
e. at least one database storing information input thereto by at least one presenter and at least one audience member;
f. an audience interface making available to at least one audience member information selected from—
i. at least one question posed by a presenter,
ii. at least one question posed by other audience members,
iii. data from a presenter,
iv. data from at least one other audience member, and
v. analysis of responses to at least one question, data from a presenter, or data from at least one audience member;
g. a presenter interface making available to at least one presenter information selected from—
i. a question posed by a presenter,
ii. a question posed by other audience members,
iii. data from a presenter,
iv. data from at least one audience member,
v. information from the database, and
vi. analysis of the preceding categories of information.

18. The system of claim 17, information sent by at least one of the following means HTTP, MMS, and SMS.

19. The system of claim 18, the central server retaining at least one account for at least one presenter and for retaining data associated with at least one presentation offered by that presenter.

20. The system of claim 19 the server further retaining at least account for at least one audience member and for retaining data associated with at least one presentation in which that audience member participates.

21. The system of claim 20, the audience device giving an audience member the capability to input into the system for display to at least a presenter at least one of the following—
a. a text-based observation related to the presentation,
b. their level of agreement with a text-based observation of at least one other audience member,
c. a response to a question posed by a presenter, and
d. a response to a question posed by another audience member.

22. The system of claim 19, the presenter interface having a display screen showing at least audience input and providing the option of selecting particular audience input for segregation into at least one of the following categories of audience inputs:
a. audience input displayed on at least one audience device;
b. audience input retained for future use by a presenter; and
c. audience input posed to the audience as a question.

23. The system of claim 22, audience input selected by at least one of the following mechanisms for segregation into one of the categories:
a. presenter selection;
b. audience selection; and
c. selection by audience input satisfying specified statistical criteria.

24. The system of claim 23, the audience interface offering each audience member the capability to input into the system for display to at least a presenter at least one of the following—
a. a text-based observation related to the presentation,
b. their level of agreement with a text-based observation of at least one other audience member,
c. a response to a question posed by a presenter, and
d. a response to a question posed by another audience member.

25. An audience response system comprising:
a. a communication network—
i. selected from at least one of a cellular telephone network, a wireless computer network, and a wired computer network, and
ii. further using at least one of HTTP, MMS, and SMS;
b. a central server for storing system data and facilitating communication among devices connected to the system;
c. at least one audience device adapted to facilitate audience input and viewing data sent to it by the system, including the capability to input into the system for display to at least a presenter at least one of the following—
i. a text-based observation related to the presentation,
ii. their level of agreement with a text-based observation of at least one other audience member,
iii. a response to a question posed by a presenter, and
iv. a response to a question posed by another audience member;
d. at least one presenter device adapted to allow a presenter to input data and to view data sent to it by the system;
e. at least one database storing information input thereto by at least one presenter and at least one audience member, the database retaining at least one account for at least one presenter and for retaining data associated with at least one presentation offered by that presenter;
f. a browser-based audience interface making available to at least one audience member information selected from
i. at least one question posed by a presenter,
ii. at least one question posed by other audience members,
iii. data from a presenter,
iv. data from at least one other audience member, and
v. analysis of responses to at least one question, data from a presenter, or data from at least one audience member; and
g. a browser-based presenter interface making available to at least one presenter information selected from—
i. a question posed by a presenter,
ii. a question posed by other audience members,
iii. data from a presenter,
iv. data from at least one audience member,
v. information from the database, and
vi. analysis of data from the audience.
